(19) United States
(12) Patent Application Publication
(10) Pub. No.: US 2012/0133896 A1
(43) Pub. Date: May 31, 2012

(54) Projection-type Image Display Device

(75) Inventor: Makoto MAEDA, Nara-shi (JP)

(73) Assignee: SANYO ELECTRIC CO., LTD., Osaka (JP)

(21) Appl. No.: 13/304,608

(22) Filed: Nov. 25, 2011

(30) Foreign Application Priority Data
Nov. 26, 2010 (JP) 2010-263522

(51) Int. Cl. G03B 21/14

(52) U.S. Cl. 353/20

(57) ABSTRACT

An image projecting unit of a projector includes a light source; a polarization control element which controls a polarization direction of light emitted from the light source; and a projecting unit which projects the image light that passed through the optical modulation element. The control unit detects a deterioration state of the polarization control element based on the projected image which is taken by an image-taking unit when a test image representing a single color throughout a screen is projected.

This nonprovisional application is based on Japanese Patent Application No. 2010-263522 filed on Nov. 26, 2010 with the Japan Patent Office, the entire contents of which are hereby incorporated by reference.

### BACKGROUND OF THE INVENTION

1. Field of the Invention

The present invention relates to a projection-type image display device, and particularly to a projection-type image display device having a function of detecting a state of deterioration of optical parts.

2. Description of the Background Art

In a projection-type image display device (which may also be referred to as a “projector” hereinafter), various expendable parts having lives of predetermined times, respectively, are used and will be replaced with new ones so that they may not reach the ends of lives during use. For example, an LCD projector that uses an LCD device for projecting images includes, as such expendable parts, optical parts such as LCD panels, a light source lamp as well as polarizing plates and polarization conversion elements. These optical parts are all arranged on an optical path through which light emitted from the light source lamp travels. When the optical parts have been exposed to the light for a certain time, they thermally or chemically change to deteriorate, and therefore must be replaced.

Conventionally, in connection with a function of informing a user of a time when the light source lamp must be replaced, it has been studied to provide a projector that stores a cumulative time of use of the light source lamp and can inform the user of a remaining time before the end of life of the light source lamp. For example, such a structure has been disclosed that limit thresholds of use are set according to environments of use of the light source lamp and a filter for a cooling fan, and this structure urges a user to perform maintenance (replacement, repair and the like) of the expendable parts when the cumulative times of use of the light source lamp and the filter reach the limit thresholds of use.

In the above projector, the limit thresholds of use of the expendable parts are set based on environmental information that was entered through a environment setting screen at the start of use (at the time of delivery) of the projector. However, in view of the practical state of use of the projector, it is rare that the projector is continuously used under a constant environment of use, and the limit thresholds of use vary depending on a temperature, humidity and an amount of dust particles. Also, individual differences of the expendable parts affect the limit thresholds. Therefore, it is difficult to calculate correctly the limit thresholds of use.

In general, deterioration of image quality that is caused by deterioration of the optical parts such as LCD panels, polarizing plates and polarization conversion elements appears as color irregularities and black floating in a projected image in many cases, and therefore the users cannot easily notice such phenomena. Therefore, the user continues the use without satisfying the image quality in many cases. The further use after such deterioration of the optical parts may cause lowering of the whole life of the projector.

### SUMMARY OF THE INVENTION

A projection-type image display device according to an aspect of the invention includes a light source; a polarization control element which controls a polatization direction of light emitted from the light source; a projecting unit which projects the light that passed through the polarization control element; an image-taking unit which takes an image of the projected image; and a deterioration state detecting unit which detects a deterioration state of the polarization control element based on the projected image which is taken by the image-taking unit when a specific image representing a single color throughout a screen is projected.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an outer structure of a projection-type image display device according to an embodiment of the invention.

FIG. 2 is a control block diagram of a major portion of a projector in FIG. 1.

FIG. 3 schematically shows a structure of an image projecting unit in FIG. 2.

FIG. 4 illustrates an operation of the projector at the time of power-on.

FIG. 5 schematically shows a distribution of brightness of a projected image according to an example of an embodiment.

FIG. 6 schematically shows a distribution of brightness of a projected image according to an example of the embodiment.

FIG. 7 is a flowchart illustrating a processing procedure of deterioration state detecting processing according to the embodiment.

FIG. 8 is a flowchart illustrating an operation of the projector at the time of power-on.

### DESCRIPTION OF THE PREFERRED EMBODIMENTS

Embodiments of the invention will now be described in details with reference to the drawings. In the following description, the same or corresponding portions bear the same reference numbers, and description thereof is not repeated.

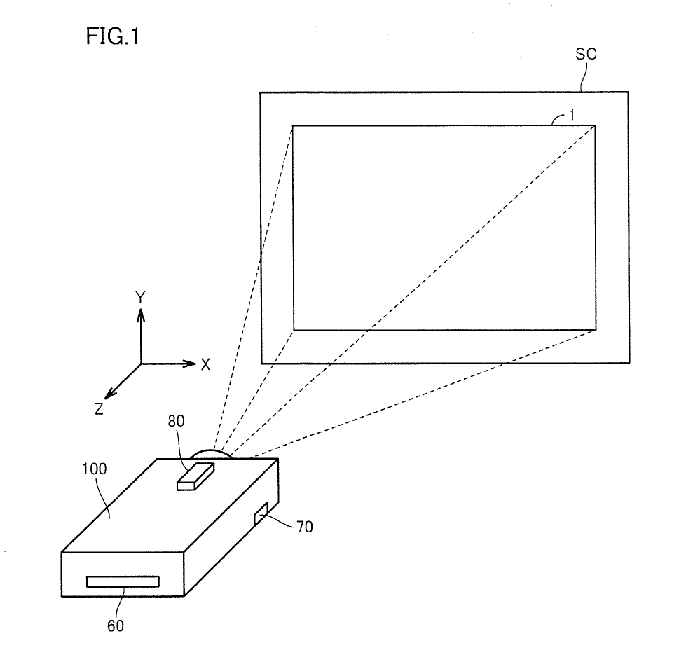

FIG. 1 shows an outer structure of a projection-type image display device according to an embodiment of the invention.

Referring to FIG. 1, a projection-type image display device (which may also be referred to as a “projector” hereinafter) 100 according to the embodiment is an LCD projector that uses an LCD device for projecting the images, and displays a projected image 1 by projecting light of the image displayed by the LCD device onto a screen SC. The projection plane is not restricted to screen SC, and may be a wall surface.

Projector 100 includes an image-taking unit 80 that produces a taken-image by taking an image of a region including projected image 1 through an image-taking plane. Image-taking unit 80 includes an image-taking element, an image-taking element control unit that controls the image-taking element for, e.g., obtaining an output signal from each image element of the image-taking element and an image-taking optical system. For example, the image-taking element may be a CCD (Charge Coupled Device), a CMOS (Complementary Metal-Oxide Semiconductor) or the like. A scope of the image taken by image-taking unit 80 is large enough to accommodate projected image 1.

Projector 100 further includes an input unit 60 and an operation accepting unit 70. Input unit 60 includes an input port for accepting an image signal (not shown) supplied from an external signal supply device (not shown). The signal supply devices include a digital signal supply device for providing digital signals of a DVD (Digital Versatile Disc) player, a Blu-Ray disc player and an analog signal supply device such as a computer that provides analog signals.

Operation accepting unit 70 receives an infrared-modulated remote control signal transmitted from a remote control operated by a user. The remote control signal includes a command signal for remotely controlling projector 100.

In addition to the remote control signal, operation accepting unit 70 can also receive a signal from an operation unit (not shown) that is arranged on a main unit of projector 100 and has a plurality of operation buttons for operating projector 100.

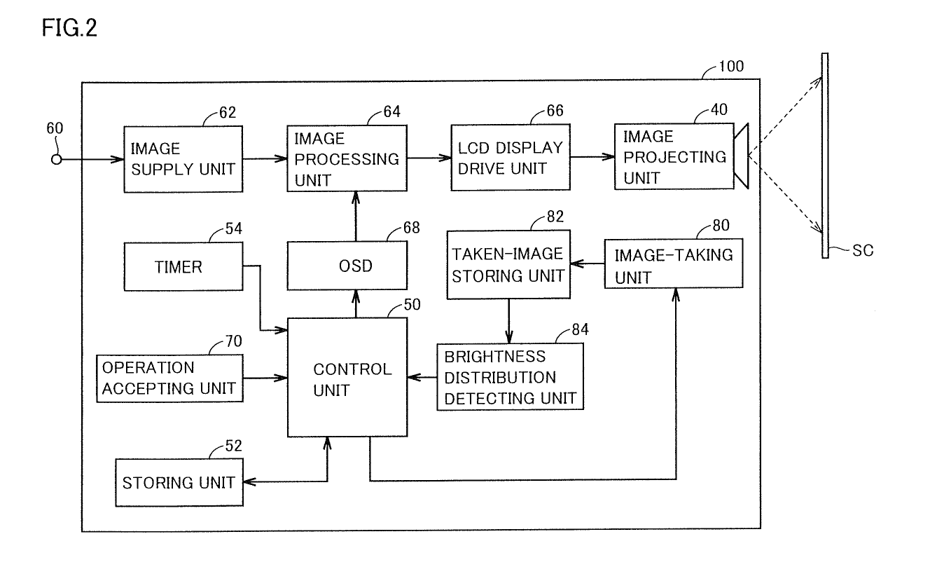

FIG. 2 is a control block diagram of a major portion of projector 100 in FIG. 1.

Referring to FIG. 2, projector 100 includes an image supply unit 62, an image processing unit 64, an LCD display drive unit 66, an OSD (On Screen Display) circuit 68, an image projecting unit 40, a control unit 50, a storing unit 52 and a timer 54.

Image supply unit 62 supplies the image data to image processing unit 64. Specifically, image supply unit 62 is connected to input unit 60 for converting the image signal provided from input unit 60 into image data of a format allowing processing by image processing unit 64 and providing it to image processing unit 64.

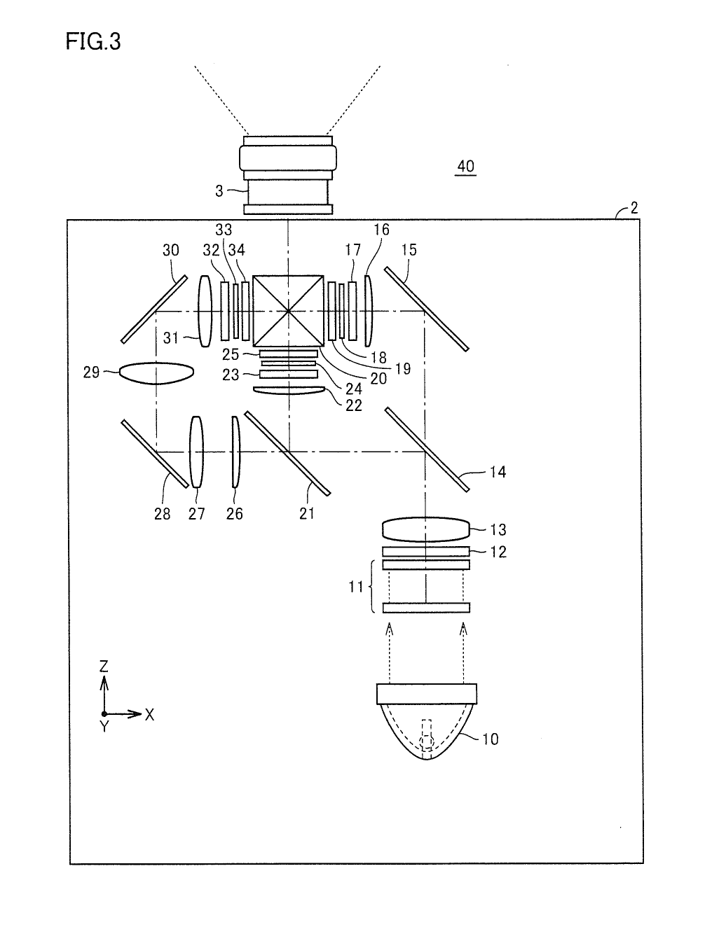

Based on an instruction from control unit 50, image processing unit 64 performs, on the image data supplied from image supply unit 62, various kinds of image quality adjustments such as resolution conversion for matching the resolution with resolutions (numbers of image elements) of LCD panels 18, 24 and 33 (FIG. 3), brightness adjustment, contrast adjustment and sharpness adjustment, and provides the image signal to LCD display drive unit 66. The image signal provided from image processing unit 64 is formed of a plurality of image element values corresponding to all the image elements of LCD panels 18, 24 and 33. The image element value determines a light transmission factor of the corresponding image element.

LCD display drive unit 66 that operates according to the image signal provided from image processing unit 64 produces the drive signal for controlling an operation of displaying images by image projecting unit 40, and provides it to image projecting unit 40. As a result, image projecting unit 40 projects the image (image light) according to the image signal.

FIG. 3 schematically shows the structure of image projecting unit 40 in FIG. 2. Referring to FIG. 3, image projecting unit 40 includes an optical engine 2 and a projection lens 3.

Optical engine 2 includes a light source 10. Light source 10 is formed of a light source lamp of a discharge light-emission type such as an extra-high voltage mercury lamp or a metal hydride lamp. Further, instead of the light source lamp of the discharge light-emission type, it may employ various kinds of solid light-emission elements such as an LED (Light Emitting Diode), a laser diode, an organic EL (Electro Luminescence) element and a silicon light-emission element.

The light emitted from light source 10 enters a PBS (Polarization Beam Splitter) array 12 and a condenser lens 13 through a fly-eye integrator 11. Fly-eye integrator 11 includes a fly-eye lens formed of a fly-eye-like lens group, and performs an optical operation on the light emitted from light source 10 so that the quantities of light entering LCD panels 18, 24 and 33 may indicate uniform distributions of light quantities.

PBS array 12 includes a plurality of PBSs and ½ wavelength plates in an array form, and uniformizes the polarization direction of the light incident from fly-eye integrator 11. Condenser lens 13 performs a light-gathering operation on the light incident from PBS array 12. The light passed through condenser lens 13 enters a dichroic mirror 14.

Dichroic mirror 14 passes only the light in a blue wave range (which will be referred to as “B light”, hereinafter) in the light incident from condenser lens 13, and reflects the light (which will be referred to as “R light” hereinafter) in the red wave range and the light in the green wave range (which will be referred to as “G light”, hereinafter). The B light passed through dichroic mirror 14 is led to a mirror 15, and is reflected thereby to enter a condenser lens 16.

Condenser lens 16 performs an optical operation on the B light so that the B light may enter LCD panel 18 as substantially parallel rays. The B light passed through condenser lens 16 enters LCD panel 18 through an incident polarizing plate 17. LCD panel 18 is driven according to an image signal for blue to modulate the B light according to the drive state thereof. The B light modulated by LCD panel 18 enters a dichroic prism 20 through an outgoing polarizing plate 19.

The G light in the light reflected by dichroic mirror 14 is reflected by a dichroic mirror 21 to enter a condenser lens 22. Condenser lens 22 performs an optical operation on the G light so that the G light may enter LCD panel 24 as substantially parallel rays. The G light passed through condenser lens 22 enters LCD panel 24 through an incident polarizing plate 23. LCD panel 24 is driven according to an image signal for green to modulate the G light according to its driven state. The G light modulated by LCD panel 24 enters dichroic prism 20 through an outgoing polarizing plate 25.

The R light passed through dichroic mirror 21 enters a condenser lens 26. Condenser lens 26 performs an optical operation on the R light so that the R light may enter LCD panel 33 as substantially parallel rays. The R light passed through condenser lens 26 travels through a light path formed of relay lenses 27, 29 and 31 as well as two mirrors 28 and 30 which are arranged for adjusting a light path length, and enters LCD panel 33 through an incident polarizing plate 32. LCD panel 33 is driven according to an image signal for red, and modulates the R light according to its driven state. The R light modulated by LCD panel 33 enters dichroic prism 20 through an outgoing polarizing plate 34.

Dichroic prism 20 performs color composition on B, G and R light beams modulated by LCD panels 18, 24 and 33, and provides the produced light to projection lens 3. Projection lens 3 includes a lens group for imaging the projected light on screen SC, as well as an actuator for adjusting states of zooming and focusing of the projected image by changing a part of lens in the group in the optical axis direction. Projection lens 3 projects the light that is color-combined by dichroic prism 20 onto screen SC in an enlarged form.

Referring to FIG. 2 again, LCD display drive unit 66 applies drive voltages corresponding to image signals provided from image processing unit 64 to respective image elements in LCD panels 18, 24 and 33. Each image element is set to have a light transmission factor corresponding to the image signal. Thereby, the light emitted from light source 10 is modulated by passing through LCD panels 18, 24 and 33 so that image light corresponding to the image signal is formed for each kind of light. The image light of each color thus formed is combined with the others for each image element by a color-composition optical system to form the image color light representing the color image, and is projected in the enlarged form onto screen SC by projection lens 3.

Control unit 50 includes a CPU (Central Processing Unit), an ROM (Read Only Memory) formed of a flash memory or the like, an RAM (Random Access Memory) used for purposes such as temporarily storing various kinds of data and others, and the like (none of which is shown), and functions as a computer. Control unit 50 generally controls the operations of projector 100 by the operation of the CPU according to control programs stored in storing unit 52. These control programs include a “deterioration state detecting program”, i.e., a program for detecting states of deterioration of polarization control elements to be described later.

According to an instruction provided from control unit 50, OSD circuit 68 produces, as OSD image signals, characters and symbols indicating various states of projector 100 as well as menu images for performing image distortion correction, image quality adjustment, operation condition setting and the like, and warning images for recommending a user to perform maintenance on the optical parts in a deterioration state detecting processing to be described later. These images (which will be referred to as “OSD images” hereinafter) are provided to image processing unit 64. Image processing unit 64 combines the OSD image signal with the image signal for the image to be projected, and provides the combined image signals to LCD display drive unit 66. When the OSD image is not displayed, image processing unit 64 does not perform the above combining processing, and provides the image signal to LCD display drive unit 66 as it is.

When an operation unit or a remote controller is operated, operation accepting unit 70 accepts the operation to send command signals serving as triggers for various operations to control unit 50.

In the structure shown in FIG. 2, projector 100 according to the embodiment further includes image-taking unit 80, a taken-image storing unit 82 and a brightness distribution detecting unit 84. When control unit 50 receives an instruction for turning on projector 100 through operation accepting unit 70, control unit 50 starts the power supply to various units of projector 100 to perform a series of initializing processing such as turning on light source 10. Then, control unit 50 controls image-taking unit 80, taken-image storing unit 82 and brightness distribution detecting unit 84 to detect the states of deterioration of the polarization control elements based on the brightness of the projected image.

Specifically, based on the instruction from control unit 50, image-taking unit 80 takes an image of the projected image to obtain the taken-image data. Taken-image storing unit 82 stores the taken-image data obtained by image-taking unit 80.

Brightness distribution detecting unit 84 calculates the brightness distribution of the projected image based on the taken-image data stored in taken-image storing unit 82. Brightness distribution detecting unit 84 provides the brightness distribution of the projected image thus calculated to control unit 50.

Control unit 50 detects the states of deterioration of the optical parts based on the brightness distribution of the projected image detected by brightness distribution detecting unit 84. The optical parts include polarization control elements such as PBS array 12, incident polarizing plates 17, 23 and 32, outgoing polarizing plates 19, 25 and 34, and LCD panels 18, 24 and 33 (FIG. 3). When it is determined from this detection that the degree of deterioration of the polarization control elements has reached a limit value that allows further use of the polarization control elements, control unit 50 warns the user of recommending maintenance of the polarization control elements.

[Deterioration State Detecting Processing]

The deterioration state detecting processing executed by projector 100 according to the embodiment of the invention will be described below with reference to the drawings.

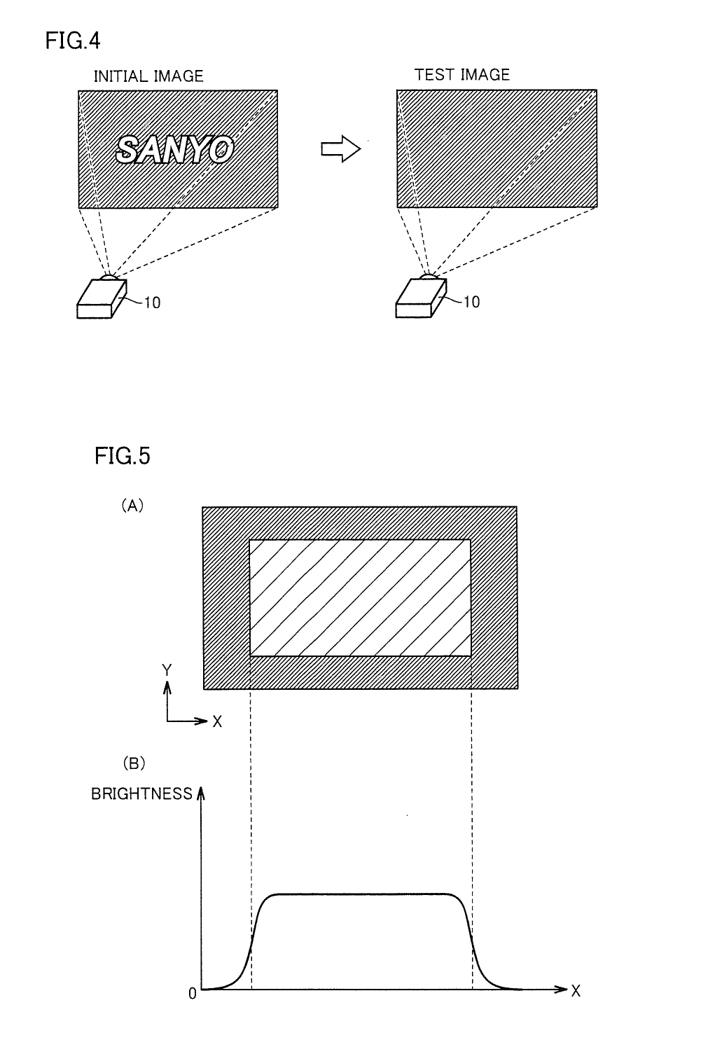

FIG. 4 illustrates an operation of projector 100 at the time of power-on.

Referring to FIG. 4, when the power is turned on to supply the power supply voltage to control unit 50, the CPU in control unit 50 starts the initialization and control of the various units of projector 100 according to the control program stored in the ROM. By this initialization, control unit 50 enables the various units of projector 100. Specifically, it sends signals for enabling to image processing unit 64, LCD display drive unit 66 and OSD circuit 68, and thereby initializes the various units. For units that require setting for specifying operation conditions and the like, control unit 50 sets predetermined values (initial values). Further, control unit 50 initializes timer 54.

Then, control unit 50 initializes a light source control unit (not shown), and instructs it to turn on (i.e., to apply a voltage to) light source 10 (FIG. 3). As described above, light source 10 is made of the light source lamp of the discharge light-emission type. Therefore, it requires a time of several tens of seconds to attain a sufficient brightness and a stable on-state after the start of lighting up. Timer 54 counts the time elapsed since light source 10 started lighting, and provides a count to control unit 50.

As shown in FIG. 4, control unit 50 projects the predetermined image (initial image) until light source 10 enters the stable on-state. Specifically, control unit 50 instructs OSD circuit 68 to produce the OSD image signal (initial image signal) indicating the initial image. OSD circuit 68 provides the initial image signal thus produced to image processing unit 64. Image processing unit 64 stores the provided initial image signal in a frame memory (not shown), and provides it to LCD display drive unit 66. LCD display drive unit 66 produces a drive signal for controlling the image display operation performed by image projecting unit 40 based on the initial image signal, and provides it to image projecting unit 40. Consequently, image projecting unit 40 projects the initial image corresponding to the initial image signal. When light source 10 is correctly turned on at this point in time, light source 10 will increase its brightness with time, and the projected initial image will become visible. By displaying the initial image in this manner, the user can recognize that projector 100 is in a preparing state, before the turned-on state becomes stable to allow the projection of the image corresponding to the input image signal.

When the count of timer 54 reaches an initial value thereafter, control unit 50 determines that the turned-on state of light source 10 becomes stable. According to the deterioration state detecting program stored in the ROM, control unit 50 starts to detect the deterioration state of the optical parts in projector 100.

The optical parts that are the detecting targets include the polarization control elements (PBS array 12, incident polarizing plates 17, 23 and 32, outgoing polarizing plates 19, 25 and 34, and LCD panels 18, 24 and 33). These polarization control elements are arranged on a light path through which the light emitted from light source 10 passes. When the optical characteristics of the polarization control elements deteriorate due to thermal and chemical influences of the passing light, the image quality may deteriorate as described below.

(Deterioration of the PBS Array)

PBS array 12 is formed of a plurality of PBSs and half-wave plates arranged in an array fashion. The PBS has a form defined by pasting together a plurality of columnar transparent members each having a parallelogrammic section. Polarization separation films and reflection films are alternately arranged on interfaces between the plurality of transparent members. The polarization separation film reflects the S-polarized light, and passes the P-polarized light. The reflection film reflects the S-polarized light.

The half-wave plate is formed of organic oriented film, is arranged on the outgoing side of the PBS and is fixed, e.g., by adhesion, to a portion where a light beam passes through the polarization separation film. The half-wave plate has a function of changing the polarization direction of linearly polarized light, and converts the S-polarized light and P-polarized light into the P-polarized light and S-polarized light, respectively.

When the light beams enter the PBS, the polarization separation film separates it into two kinds of linearly polarized light by reflecting the S-polarized light and passing the P-polarized light. The S-polarized light separated by the polarization separation film is reflected by the reflection film and is emitted from the PBS. The P-polarized light passed through the polarization separation film passes through the PBS and enters the half-wave plate. The P-polarized light entering the half-wave plate is converted into the S-polarized light and is emitted therefrom.

In this manner, PBS array 12 changes the incident light into the uniform polarized light having the S-polarized light. In this operation, PBS array 12 generates a heat by partially absorbing the P-polarized light and S-polarized light. In particularly, when the half-wave plate deteriorates in function of converting the polarized light due to heat generation, it cannot appropriately filter the polarized light so that unnecessary polarization components increase and irregularities occur in color of the projected image. When the user continues the use of PBS array 12 in which the function of the half-wave plate is deteriorated, overheating may damage the half-wave plate as well as the surrounding optical parts. In many cases, the irregularities in color of the projected image due to the deterioration of PBS array 12 randomly occur on the screen.

(Deterioration of the Incident and Outgoing Polarizing Plates)

Incident polarizing plates 17, 23 and 32 are configured to act on the light separated by dichroic mirrors 14 and 21 as well as mirrors 15, 28 and 30 to pass the S-P-polarized light and to absorb the P-polarized light, and is formed by pasting polarizing films onto transparent base plates, respectively. Incident polarizing plates 17, 23 and 32 generates the heat by absorbing a part of the S- and P-polarized light. When the optical characteristics of incident polarizing plates 17, 23 and 32 deteriorate due to such heat generation, the filtering cannot be appropriately performed on the polarized light so that unnecessary polarized light components increase. Consequently, when a black image is projected, black floating occurs on the screen. When a white image is projected, irregularities in color occur on the screen.

Outgoing polarizing plates 19, 25 and 34 have substantially the same functions as incident polarizing plates 17, 23 and 32, and act on the light emitted from LCD panels 18, 24 and 33 to pass the S-polarized light and to absorb the P-polarized light. Outgoing polarizing plates 19, 25 and 34 generate the heat by absorbing a part of the S- and P-polarized light. When the optical characteristics of outgoing polarizing plates 19, 25 and 34 deteriorate due to this heat generation, black-floating and irregularities in color occur in the projected image.

The deterioration states of the incident and outgoing polarizing plates depend on the color light. In this embodiment, light source 10 is the light source lamp of the discharge light-emission type. Therefore, in the light required for obtaining the white light, the intensity of the G light is smaller than those of the R light and B light. Therefore, the degree of deterioration of outgoing polarizing plate 25 that passes the G light emitted from LCD panel 24 is larger than those of outgoing polarizing plate 19 passing the R light and outgoing polarizing plate 34 passing the B light.

Incident polarizing plate 32 that receives the B light having a shorter wavelength than R light and G light passes the B light and absorbs ultraviolet light so that the degree of deterioration of incident polarizing plate 32 is larger than those of incident polarizing plates 17 and 23 receiving the R light and the G light, respectively.

The incident polarizing plates and the outgoing polarizing plates are cooled by cooling air supplied from a cooling device (not shown). However, the cooling air flows through gaps between the incident and outgoing polarizing plates and the LCD panels, and such gaps are narrow. In each of the incident and outgoing polarizing plates, therefore, there is a tendency that a temperature in a central portion is higher than that in a surrounding portion. Consequently, the degree of deterioration of the central portion of the polarizing plate is larger than that of the surrounding portion so that the black floating and the irregularities in color due to the above deterioration of the incident and outgoing polarizing plates occur in the central portion of the projected image in many cases.

(Deterioration of the LCD Panel)

In addition to the deterioration of the polarizing elements (the PBS array and the incident and outgoing polarizing plates) described above, the deterioration likewise progresses in LCD panels 18, 24 and 33 due to long-term use. Each of LCD panels 18, 24 and 33 has a structure in which an electrooptical substance, i.e., LCD fills a sealed space between paired transparent glass substrates, and modulates the polarization direction of the polarized light emitted from incident polarizing plate 17, 23 or 32 by controlling the orientation state of the LCD according to the drive signal provided from LCD display drive unit 66. In each of LCD panels 18, 24 and 33, the state of deterioration likewise depends on the color light. In general, the degree of deterioration of LCD panel 33 on the B light side (i.e., short-wavelength side) is larger than those of LCD panels 18 and 24 on the R and G light sides, respectively. In particular, the polarizing film in the LCD film is liable to deteriorate. When the deterioration of the orientation film disorders the orientation state of the LCD, the polarized light cannot be appropriately modulated, which causes such deterioration in image quality that the image cannot be appropriately displayed in a specific region of the screen.

The deterioration in the PBS array, incident and outgoing polarizing plates and the LCD panels has been described as an example of the deterioration state of the optical parts in the LCD projector. However, in a projector of a DLP (Digital Light Processing) type, a quality of a projected image lowers due to deterioration of a DMD (Digital Micro-Mirror Device) panel, color wheel or the like.

(Detection of the Deterioration State)

A specific manner of detecting the deterioration state of the polarization control elements will be described below with reference to the drawings.

First, control unit 50 projects a specific image (which will be referred to as a “test image” hereinafter) for detecting the deterioration state. As shown in FIG. 4, this test image is formed of, e.g., a black solid image (fully black image). Image processing unit 64 receives from control unit 50 an instruction to project the fully black image, produces an image signal for minimizing the light transmission factor of each image element and provides it to LCD display drive unit 66. According to the image signal provided from image processing unit 64, LCD display drive unit 66 drives LCD panels 18, 24 and 33 so that the fully black image is formed and projected from projection lens 3.

Image-taking unit 80 takes a image of screen SC onto which the fully black test image is projected. Taken-image storing unit 82 stores the taken image data obtained by image-taking unit 80. Based on the taken image data, brightness distribution detecting unit 84 determines between the region corresponding to the projected image and the remaining region. Brightness distribution detecting unit 84 calculates the brightness distribution of the projected image.

FIG. 5 schematically shows the distribution of brightness of the projected image according to an example of the embodiment.

In an example of the projected image shown in FIG. 5(A), the central portion of the screen is brighter than the surrounding portion. Brightness distribution detecting unit 84 integrates the brightness values of the respective image elements of the projected image with respect to the horizontal direction (X direction) and the vertical direction (Y direction). Specifically, brightness distribution detecting unit 84 integrates (adds) the brightness values of the respective image elements of the projected image in the vertical direction, and thereby produces the data representing the relationship between the horizontal direction and the integrated brightness as shown in FIG. 5(B). Likewise, brightness distribution detecting unit 84 integrates the brightness values of the respective image elements of the projected image in the horizontal direction, and thereby produces the data representing the relationship between the vertical direction and the integrated brightness. Brightness distribution detecting unit 84 provides the produced data to control unit 50.

Based on the data produced by brightness distribution detecting unit 84, control unit 50 determines the states of deterioration of the polarization control elements. Specifically, control unit 50 has obtained in advance the data representing the relationship between the deterioration states of the polarization control elements and the integrated brightness of the projected image, and determines the deterioration state of the polarization control elements by making a comparison between the data produced by brightness distribution detecting unit 84 and the data already obtained.

In the example in FIG. 5, in accordance with that fact that the projected image in the central portion of the screen is brighter than that in the surrounding portion (FIG. 5(A), the brightness value in the horizontal direction is high in the central portion of the screen as compared with that in the surrounding portion (FIG. 5(B)). Control unit 50 compares the data shown in FIG. 5(B) with the data that is already obtained, and thereby determines that at least incident polarizing plates 17, 23 and 32 or outgoing polarizing plates 19, 25 and 34 have exhibited the degree of deterioration exceeding the limit value of use, and are in the state not allowing further use. This is based on the fact that the black floating in the projected image due to the deterioration of the incident and outgoing polarizing plates occurs in the central port of the screen in many cases.

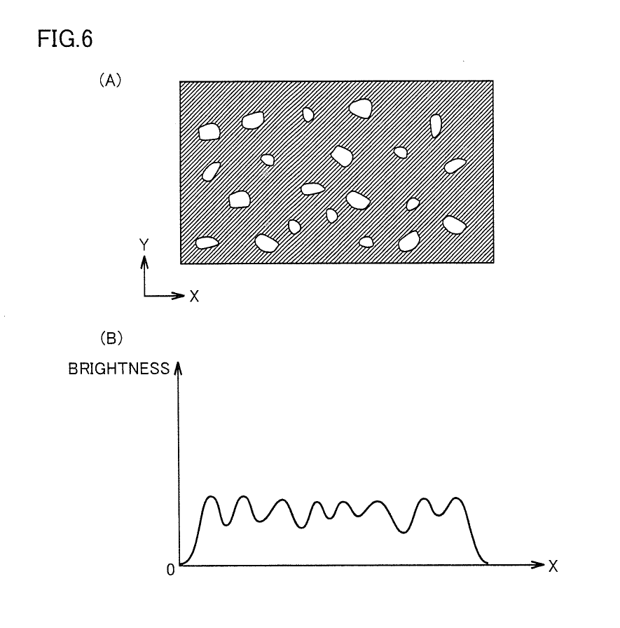

FIG. 6 schematically shows a distribution of brightness of a projected image according to an example of an embodiment.

In the example of the projected image shown in FIG. 6(A), portions that are brighter than the other portion are scattered on the screen. Brightness distribution detecting unit 84 integrates the brightness values at respective image elements of the projected image in the horizontal direction (X direction) and the vertical direction (Y direction). Specifically, brightness distribution detecting unit 84 integrates (adds) the brightness values at respective image elements of the projected image in the vertical direction, and thereby produces the data representing the relationship between the horizontal direction and the integrated brightness as shown in FIG. 6(B). Likewise, brightness distribution detecting unit 84 integrates the brightness values at respective image elements of the projected image in the horizontal direction, and thereby produces the data representing the relationship between the vertical direction and the integrated brightness. Brightness distribution detecting unit 84 provides the produced data to control unit 50.

Control unit 50 makes a comparison between the data produced by brightness distribution detecting unit 84 and the data that is obtained in advance and indicates the relationship between the deterioration state of the polarization control elements and the integrated brightness of the projected image, and thereby determines the deterioration state of the polarization control elements.

In the example shown in FIG. 6, portions exhibiting high brightness values in the horizontal direction are likewise present in a random fashion (FIG. 6(B)) according to the fact that bright portions are scattered in the projected image on the screen (FIG. 6(A)). In this case, control unit 50 determines that the degree of deterioration of PBS array 12 has exceeded the limit value of use, and that the current state does not allow further use. This is based on the fact that the irregularities in color of the projected image due to deterioration of PBS array 12 randomly occur on the screen, as described before.

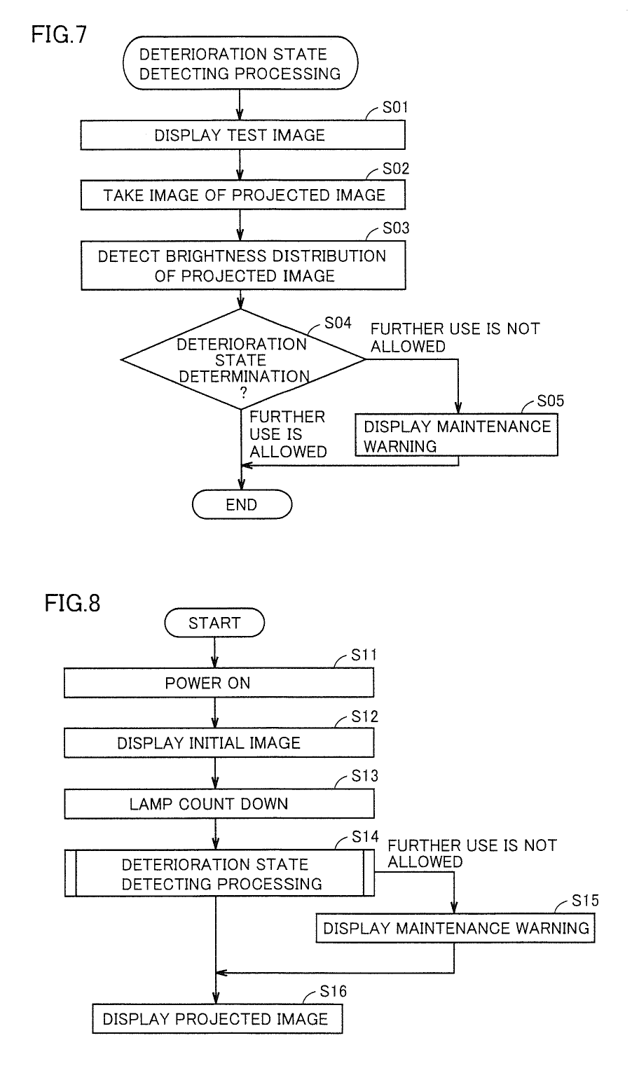

The above processing can be summarized in a process flow shown in FIG. 7.

(Flowchart)

FIG. 7 is a flowchart illustrating a processing procedure of the deterioration state detecting processing according to the embodiment. Each step shown in FIG. 7 is implemented by the CPU in control unit 50 operating according to the deterioration state detecting program stored in storing unit 52.

Referring to FIG. 7, control unit 50 first instructs image processing unit 64 to project the test image (fully black image, see FIG. 4) (step S01).

Then, control unit 50 causes image-taking unit 80 to take the image of the projected test image (step S02). Taken-image storing unit 82 stores the taken-image data obtained by image-taking unit 80.

Then, control unit 50 instructs brightness distribution detecting unit 84 to calculate the brightness distribution of the projected image (step S03). Specifically, brightness distribution detecting unit 84 integrates the brightness values of the respective image elements of the projected image in the horizontal direction and the vertical direction, and thereby produces the data representing the relationship of the integrated brightness with respect to the horizontal and vertical directions.

Then, control unit 50 determines the states of deterioration of the polarization control elements based on the data produced by brightness distribution detecting unit 84 (step S04). Specifically, control unit 50 compares the data representing the relationship between the horizontal direction and the integrated brightness and the data representing the relationship between the vertical direction and the integrated brightness with the data that has already been obtained and represents the relationship between the deterioration state of the polarization control element and the integrated brightness of the projected image. For example, control unit 50 detects, from the data produced by brightness distribution detecting unit 84, the coordinate positions of the image elements of which brightness values exceed a predetermined threshold. When it is determined, based on the coordinate positions thus detected, that the predetermined region containing the central portion of the projected image on the screen contains at least a predetermined number of image elements of which the brightness values exceed the predetermined threshold, it is determined that at least incident polarizing plates 17, 23 and 32 or outgoing polarizing plates 19, 25 and 34 have the deterioration degree exceeding the limit value of use, and the current state does not allow further use.

When it is determined from the data produced by brightness distribution detecting unit 84 that the image elements of which the brightness values exceed the predetermined threshold are present in a random fashion in the projected image on the screen, control unit 50 determines that the degree of deterioration of PBS array 12 has exceeded the limit value of use, and the current state does not allow further use.

In the embodiment, the brightness values of the image elements are directly used for determining the deterioration state of the polarization control elements. However, the values of differences in brightness value between the image elements may be used. Instead of the brightness values, index values of various kinds of brightness such as illuminance, luminosity and the like may be employed. Further, lines in the horizontal and vertical directions of the image elements forming the image are used as the processing units for analyzing the brightness. However, the image elements, image element blocks and the like may be used as the processing units.

In the above processing of determining the deterioration state, when it is determined that the degree of deterioration of the polarization control elements has exceeded the limit value of use and the current state does not allow further use, control unit 50 instructs OSD circuit 68 to produce an OSD image signal (warning image signal) representing a warning image for recommending the user to perform maintenance of the polarization control elements. OSD circuit 68 provides the warning image signal thus produced to image processing unit 64. Image processing unit 64 stores the provided warning image signal in a frame memory (not shown), and provides it to LCD display drive unit 66. LCD display drive unit 66 produces, based on the warning image signal, a drive signal for controlling the image display operation of image projecting unit 40, and provides it to image projecting unit 40. Consequently, image projecting unit 40 projects the warning image (step S05). In the determination processing in step S04, when it is determined that the deterioration degree of the polarization control elements is low, and the current state allows further use, the processing ends.

According to the embodiment, as described above, projector 100 can detect, based on the taken-image information of the projected image, the states of deterioration of the polarization control elements that are the optical parts forming image projecting unit 40. Based on the detected state of deterioration, warning is issued for recommending the user to perform the maintenance, and thereby it is possible to suppress the lowering of the lifetime of whole projector 100, which may be caused by the further use with the deteriorated polarization control elements. Further, it is possible to resolve user's dissatisfaction about the deterioration of the image quantity.

The warning image described above is not restricted to the image that represents the recommendation of maintenance to the user. For example, it may be an image urging the user to make contact with a manufacturer. When the warning is issued on the screen, it is desired to display the warning image on the upper or lower end portion of the screen so that it may not hinder the image projection executed based on the image signal immediately after the warning.

Instead of the warning on the screen, a warning lamp arranged on the operation unit may be turned on, or a sound may be played.

In this embodiment, as shown in FIG. 4, the deterioration state detecting processing is executed continuously to the initializing processing performed when projector 100 is powered on. FIG. 8 is a flowchart illustrating an operation of projector 100 at the time of power-on.

Referring to FIG. 8, when the power is turned on to supply the power supply voltage to control unit 50 (step S11), control unit 50 executes initializing processing for activating various portions of projector 100. Specifically, the various portions are initialized by sending the signals for the activation to image processing unit 64, LCD display drive unit 66 and OSD circuit 68. Also, predetermined values (initial values) are set in portions that require setting for defining operation conditions or the like. Further, control unit 50 initializes timer 54.

Control unit 50 initializes a light source control unit (not shown), and instructs the light source control unit to turn on (apply a voltage to) light source 10 (FIG. 3). Light source 10 is formed of the discharge light-emission type of light source lamp as described before, it requires a time of several tens of seconds to attain a sufficient brightness and a stable on-state after the start of lighting up. Timer 54 counts a time elapsed since light source 10 started the lighting, and provides a count to control unit 50.

Then, control unit 50 projects the initial image (see FIG. 4) until light source 10 attains the stable on-state (step S12). When the count of timer 54 attains the initial value (step S13), control unit 50 determines that the on state of light source 10 becomes stable. According to the deterioration state detecting program stored in the ROM, control unit 50 starts the deterioration state detecting processing shown in FIG. 7 (step S14).

When it is determined in the deterioration state detecting processing in step S14 that the polarization control element is in the state not allowing further use, control unit 50 projects the warning image (step S15). Conversely, when it is determined that the further use of the polarization control element is allowed, control unit 50 instructs image processing unit 64 to produce the image signal based on the image data supplied from image supply unit 62. According to the image signal provided from image processing unit 64, LCD display drive unit 66 produces the drive signal for controlling the image display operation of image projecting unit 40, and provides it to image projecting unit 40. As a result, image projecting unit 40 projects the image (image light) corresponding to the image signal (step S16).

As shown in FIG. 8, owing to the structure that is configured to execute the deterioration state detecting processing upon power-on, the deterioration state of the optical parts can be checked every time projector 100 is to be used so that the user can achieve appropriate operation or management depending on the deterioration state of the optical parts.

Projector 100 may be configured to execute the deterioration state detecting processing at the time other than the power-on when a user instructs it. In an example of such configuration, when a user operates a projection state adjustment button for instructing the adjustment of the projection state, the deterioration state can be detected according to timing of the automatic adjusting of the projection state.

Specifically, when the user operates the projection state adjustment button, operation accepting unit 70 detects this input operation to provide the operation signal to control unit 50. When control unit 50 receives this operation signal, processing is performed to adjust automatically the projection state (focus state, zoom state and image distortion state) of the image. At this time, control unit 50 instructs image processing unit 64 to project the test image (e.g., solid image of a single color) for adjusting the projection state from image projecting unit 40, and to take an image of the projected test image by image-taking unit 80. Control unit 50 analyzes the taken image, controls an actuator driving projection lens 3 and instructs image processing unit 64 to correct an image distortion so that the projected image may attain an appropriately projected state.

Along with such automatic adjustment of the projected image, control unit 50 calculates the brightness distribution of the projected image from the taken image, and detects the deterioration state of the optical parts based on the results of such calculation. When it is determined that the further use of the optical parts is not allowed, control unit 50 projects the warning image after the automatic adjustment of the projection state ends.

As described above, since it is configured to execute the deterioration state detecting processing when the user instructs it, it is possible to inform effectively the user of the deterioration of the optical parts which the user cannot notice without difficulty.

The embodiment has been described in connection with an example in which the deterioration state detecting processing is executed according to the timing of the automatic adjustment of the projection state. However, an operation button for instructing the detection of the deterioration state may be independently arranged, and it may be configured to execute the deterioration state detecting processing according to the input operation of the operation button.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A projection-type image display device comprising:
a light source;
a polarization control element which controls a polarization direction of light emitted from said light source;
a projecting unit which projects the light that passed though said polarization control element;
an image-taking unit which takes an image of the projected image; and
a deterioration state detecting unit which detects a deterioration state of said polarization control element based on the projected image which is taken by said image-taking unit when a specific image representing a single color throughout a screen is projected.

2. The projection-type image display device according to claim 1, wherein
said deterioration state detecting unit detects the deterioration state of said polarization control element based on a brightness distribution of the projected image taken by said image-taking unit.

3. The projection-type image display device according to claim 2, wherein
said polarization control element includes at least one of:
a polarization conversion element which separates the light emitted from said light source into first linear polarized light and second linear polarized light having polarization directions perpendicular to each other, respectively, and emits the light uniformized as the polarized light having said first linear polarized light, and
an optical modulation element which forms image light by modulating light emitted from said light source according to an input signal, and
a polarizing plate which is arranged on at least one of the incident side and the outgoing side of said optical modulation element, and acts on first linear polarized light and second linear polarized light having polarization directions perpendicular to each other, respectively, to pass said first linear polarized light and to absorb said second linear polarized light; and
said deterioration state detecting unit has obtained in advance a brightness distribution of the projected image according to deterioration states of said polarization conversion element and said polarizing plate, and detects the deterioration state of said polarization conversion element or said polarizing plate by comparing said brightness distribution with a brightness distribution of the projected image taken by said image-taking unit.

4. The projection-type image display device according to claim 1, further comprising:
a notifying unit which notifies warning for recommending maintenance of said polarization control element.

5. The projection-type image display device according to claim 1, wherein
said deterioration state detecting unit detects the deterioration state of said polarization control element according to timing of execution of initializing processing performed for initializing respective portions of said projection-type image display device at a time of power-on.

6. The projection-type image display device according to claim 1, further comprising:
an operation accepting unit which accepts an input operation for instructing automatic adjustment of a projection state, wherein
said deterioration state detecting unit detects the deterioration state of said polarization control element according to timing of execution of automatic adjustment of the projection state according to said input operation accepted by said operation accepting unit.
